(19) United States
(12) Patent Application Publication
(10) Pub. No.: US 2004/0010934 A1
(43) Pub. Date: Jan. 22, 2004

(54) Device and method for the thermal secondary treatment of polymer plastic material in granulate form

(76) Inventors: Hans Geissbuhler, Zuzwil (CH); Bernd Kuhnemund, Flawil (CH); Camille Borer, Flurlingen (CH); Filippo Terrasi, Niederuwil (CH)

Correspondence Address: MERCHANT & GOULD PC, P.O. BOX 2903, MINNEAPOLIS, MN, 55402-0903, US

(21) Appl. No.: 10/381,331

(22) PCT Filed: Jul. 9, 2001
(86) PCT No.: PCT/CH01/00428

(30) Foreign Application Priority Data
Sep. 28, 2000 (DE) 10049263.0

(51) Int. Cl. F26B 3/00

(52) U.S. Cl. 34/443

(57) ABSTRACT

The invention relates to a device for the thermal secondary treatment of plastic material in granulate form, in particular of polyester material such as polyethylene-terephthalate, in a flat shaft reactor comprising a substantially rectangular cross-section. The shaft (1) consists of an upper region (4) and a lower region (5), whose horizontal cross-section (Q5) tapers downwards in a vertical direction. At least sections of the vertical shaft walls (4A) and (4B) have screen-type gas dispersion regions. The large opposing shaft walls 5a and of the lower outlet region (5) are likewise gas dispersion regions. The gas dispersion regions consist of wedge-wire screens, which can have different arrangements of gaps according to requirements. The special gap arrangements in the wedge-wire screens allow the standardisation of the granulate speed profile over horizontal cross-sections in the shaft region. Vibrations and impact stresses of the device are reduced by the mounting of elements (“diamonds”) and the granulate speed profile is further optimised.

This invention relates to a device for thermal treatment or aftertreatment of a plastic material in granular form, in particular a polyester material such as polyethylene terephthalate (PET) according to the preamble of claim 1, as well as a corresponding method according to claim 20, which can be implemented with the device according to this invention.

Methods and devices are known for crystallization and solid-phase post-condensation of polymer plastics. For example, post-condensation of PET takes place in solid phase at temperatures above 200° C. in suitable reactors over a period of several hours.

Depending on the further use of the polymer granules, there are different requirements of the materials. For use in the food packaging industry, for example, it is important for the polymer to be free of acetaldehyde. In further processing to produce disposable or returnable beverage bottles, an especially high mechanical strength and transparency are required. To achieve a high mechanical strength, a high degree of polymerization is desired, which is achieved by higher reaction temperatures and/or longer reaction times. However, it is important to be sure that no thermolysis or oxidation of the material occurs in the process, since this can result in a yellow discoloration. On the other hand, softening of the granules must be prevented so they do not fuse together.

It is therefore important to maintain optimum reaction conditions, depending on the further use of the polymer granules, but also to ensure that all the grains of the polymer granules passing through the reactor will be exposed to the same reaction conditions over a period of time. Even if the operating conditions of the shaft reactor are kept constant over time for this purpose, one must also guarantee at the same time that all the grains of the granules remain in the reactor for an almost identical length of time.

This means that the velocity distribution of the granules over a cross section perpendicular to the vertical direction of flow should be uniform at each vertical position in the shaft. If heterogeneous velocity distributions at certain vertical positions in the shaft are allowed, they must be compensated through opposing velocity distributions at another vertical position, assuming a streamlined the flow behavior of the granules.

However, it is best if a homogeneous velocity distribution of granules is achieved at all vertical positions in the shaft, for which purpose one must ensure that there is no extremely great deviation from the desired chronologically continuous flow behavior of the granules due to an interaction of adhesive friction and sliding friction within the granules and between the granules and the inside walls of the shaft.

Therefore, the object of this invention is to achieve a homogeneous velocity distribution of the polymer granules over the cross section of the shaft on the one hand while on the other hand achieving a smooth continuous flow of granules without obstruction.

This object is achieved through the characterizing features of claim 1 with regard to the device and through claim 21 with regard to the process.

Due to the microscopically smooth insides of the shaft walls, at least in some areas, but with macroscopic structuring in the preferential directions, there are interactions between the polymer granules and the insides of the walls in the area of the wall, which thus influences the flow behavior of the granules.

These partial areas are advantageously formed by gas-permeable gassing areas having slotted and/or hole-like openings.

A transverse gassing is expediently performed in both the upper and lower areas, i.e., the outlet area of the shaft walls. This yields maximum gassing with a predetermined structural height of the shaft.

The screen-like regions for transverse gassing of the granules preferably consist of slotted-hole screens in which the slot widths are smaller than the smallest dimensions of the granules. This permits an influence on the movement of the granules starting from the areas close to the inside walls of the shaft, but this is also transmitted partially to the inside area of the shaft due to the mutual entanglement and friction between granules. This effect of the insides of the shaft on the granules is especially pronounced in the case of the present shallow design of the shaft having a rectangular cross section, because due to the shallow construction of the shaft, all the granules are situated close to the walls of the shaft.

The shaft outlet is preferably designed in a funnel shape. In terms of construction technology, a funnel-shaped outlet composed of a pair of opposing rectangular surfaces and a pair of opposing trapezoidal surfaces is especially advantageous, so that in one horizontal dimension there is a funnel-shaped constriction, while in the other horizontal dimension the full width of the shaft is retained over the entire height of the outlet. Therefore with this design, large gassing areas are possible even in the outlet area, and the rectangular sides and trapezoidal sides are preferably made entirely of slotted-hole screens. The directional distribution of the slots within the slotted-hole screen may be adapted according to the granule geometry and process conditions. Interchangeable slotted grids having different slot structures are conceivable for this purpose, for example.

Preferably, however, the slotted-hole screens consist of regions within which the slots run parallel to one another.

In another preferred embodiment of the shaft, the funnel-shaped outlet consists of a first pair of opposing trapezoidal faces and a second pair of opposing trapezoidal faces. This forms a structure like a truncated cone.

Expediently, the transverse gassing in the outlet area takes place through the opposing large-area sides. As mentioned above, these may be either trapezoidal faces or rectangular faces.

In an especially inexpensive embodiment, the opposing, large-area gassing sides consist of slotted-hole screens in which the slots run parallel to one another and extend perpendicular to the base sides of the rectangular or trapezoidal faces.

With the present shallow design of the shaft reactor, it has proven especially advantageous to have an influence on the velocity profile in the shaft reactor through a targeted constriction of the outlet as well as through a targeted structuring of the insides of the shaft. The horizontal width of the shaft is typically approximately 5 to 10 times greater than the horizontal depth of the shaft, and furthermore the horizontal depth of the shaft based on the particle size of the granules is not too large, so therefore the velocity distribution of the granules along the depth of the shaft is relatively homogeneous. However, if one considers the velocity distribution of granules over the width of the shaft, it is found that the velocity of the grains in the middle is much greater than that in the edge areas.

To equalize this unequal velocity distribution, various slotted-hole screen structures in the trapezoidal faces have been proposed in conjunction with the one-dimensional funnel-shaped constriction of the outlet along the width of the shaft.

A trapezoidal face in which the slot is situated symmetrically with the axis of symmetry of the trapezoidal face and runs parallel to the inclined sides of a trapezoidal face on both sides of the axis of symmetry is especially advantageous. Due to the arrangement of slots in the slotted-hole screen in a herringbone pattern, the granules are influenced here such that the granules in the central area of the shaft outlet are decelerated and thus the velocity profile becomes more uniform. Since the slotted-hole screens are arranged parallel to the inclined sides of the trapezoid, this slotted-hole screen structure also has the advantage that there is little waste in its manufacture.

Another preferred embodiment of the slotted-hole screen structure has slots which are also arranged symmetrically with the axis of symmetry of the trapezoidal face but run on both sides of the axis of symmetry parallel to one another and at the same time parallel to the angle bisecting line between the axis of symmetry and the respective inclined sides of the trapezoidal face. With this design, the uniformity achieved in the velocity profile is especially good, but there is an especially large amount of waste in manufacturing the slotted-hole screen.

In an especially preferred embodiment of the slotted grid, the trapezoidal face has a rectangular area which extends symmetrically around the axis of symmetry of the trapezoidal face and whose sides run parallel or orthogonal to the base sides of the trapezoidal face, the slots running parallel to the axis of symmetry of the trapezoidal face within the rectangular area. The effect of this design on making the velocity profile more uniform is equally as good as that discussed in the preceding paragraph, but it offers the advantage that there is less waste in production. In addition, the rectangular area is suitable for a less complicated change in the slotted-hole screen structure by either increasing or decreasing the width of the rectangle.

This can be accomplished through a modular design of the trapezoidal slotted hole, in which case two separate trapezoidal halves with slots parallel to the inclined sides of the trapezoid and a rectangle with slots parallel to its long sides is used. It is equally possible for the central rectangular area to be varied by more or less overlapping of a right and left half of the grid.

With the shaft outlet according to this invention, the angle between the axis of symmetry of the trapezoidal face and the inclined sides of the trapezoidal face is between 10° and 30° and preferably approximately 20°.

In the embodiment of the trapezoidal slotted grid with the central rectangular area, the length of the rectangular sides running parallel to the base sides of the trapezoidal faces amounts to approximately 1/10 of the length of the large base side of the trapezoidal face and may assume a maximum value which corresponds to the small base side of the trapezoidal face.

In the shallow design of the shaft according to this invention, the ratio of the longer rectangular side to the shorter rectangular side of the cross section perpendicular to the direction of flow of the granules is between 20:1 and 5:1. Especially good results have been achieved with a ratio of 10:1.

In all embodiments of the shaft, it is especially advantageous if all the inside edges in the upper area of the shaft as well as in the lower area of the shaft are beveled or rounded so that the horizontal cross sections are polygonal, oval (stadium bowl shape) or especially octagonal. The horizontal cross sections are therefore only approximately rectangular on closer inspection. This is especially important so that no wedging of granules occurs on the inside edges. The granules tend to stick, especially at high temperatures. Since they usually are cubical or cuboid or cylindrical in shape, there is no danger of two orthogonal wall sides presenting themselves as adhesive surfaces to an inside edge. Due to this sloping or beveling of the inside edges, caking of granules can be largely prevented.

An influence on the velocity profile of the granules in the shaft can also be achieved through targeted installation of roofs, which are arranged in such a way that their peaks point upward against the direction of flow of the granules. These roofs are preferably mounted in the central area of the shaft.

An arrangement of numerous small roofs in several horizontal rows in the upper area of the shaft is especially beneficial, where the rows of roofs are arranged with a vertical spacing between them. This has proven especially useful in restricting jerky movements of the entire granule masses contained in the shaft, and it has the advantage that due to the smaller cross section, less bypass gas goes from one zone into another zone. Without such horizontal roof rows in the upper shaft area, there may be an unpleasant interaction of adhesive friction and sliding friction of the granules with one another as well as with the inside wall of the shaft under certain process conditions and granule conditions, which can lead to powerful vibration of the entire installation because of the enormous total mass of all the granules. The horizontal roof rows yield a separation of different areas of the total volume of granules, so that such an interaction of adhesive friction and sliding friction (“slip-stick”) occurs only separately for the individual areas, so that the vibrations can be greatly reduced due to the smaller total mass and the shorter height of fall. Due to the changes in velocity of the granules at the constrictions of the roofs, this yields asynchronous vibrations of smaller partial masses of the total granules in the shaft instead of asynchronous jerking throughout the entire mass of granules.

The roofs are preferably mounted on the insides of the opposing large shaft walls. This makes an additional contribution toward stabilization of the entire shaft structure.

Additional advantages, features and possible applications of this invention are derived from the following description of preferred embodiments of this invention on the basis of the drawings, although these embodiments do not restrict the scope of this invention in any way, wherein:

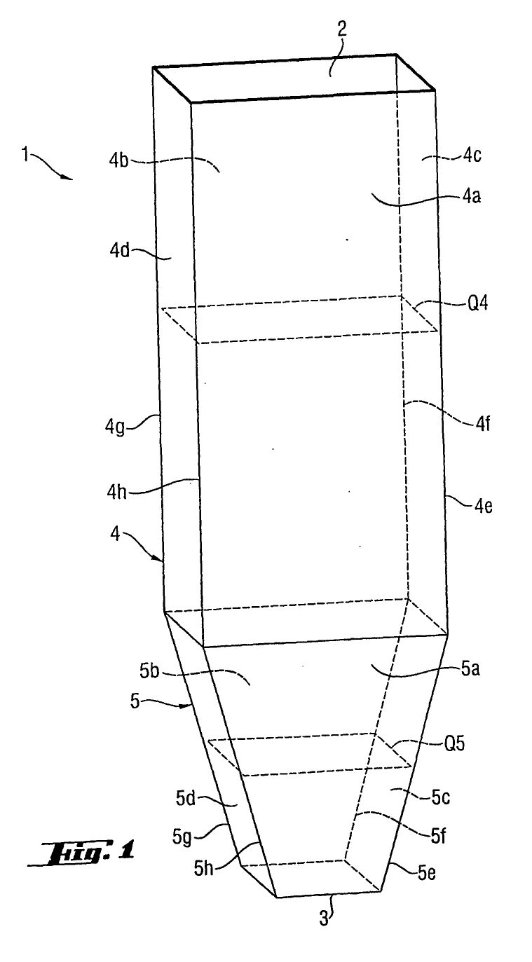

FIG. 1 shows a schematic prospective view of the shaft according to this invention.

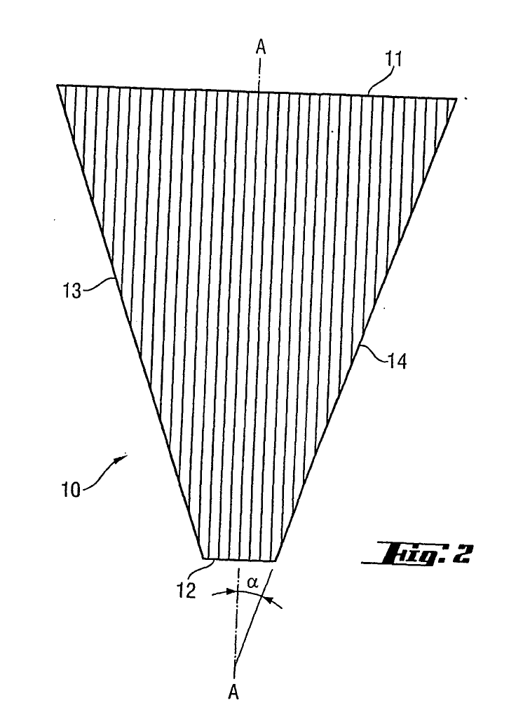

FIGS. 2, 3, 4, 5 and 6 show various embodiments of slotted-hole screens according to this invention;

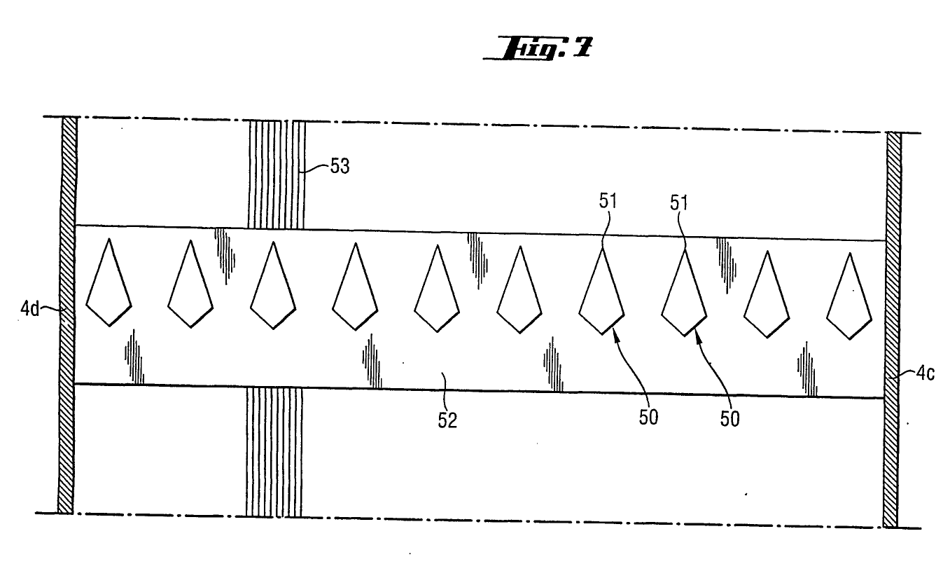

FIG. 7 is a schematic cross-sectional view along a sectional plane parallel to sides 4a and 4b in FIG. 1;

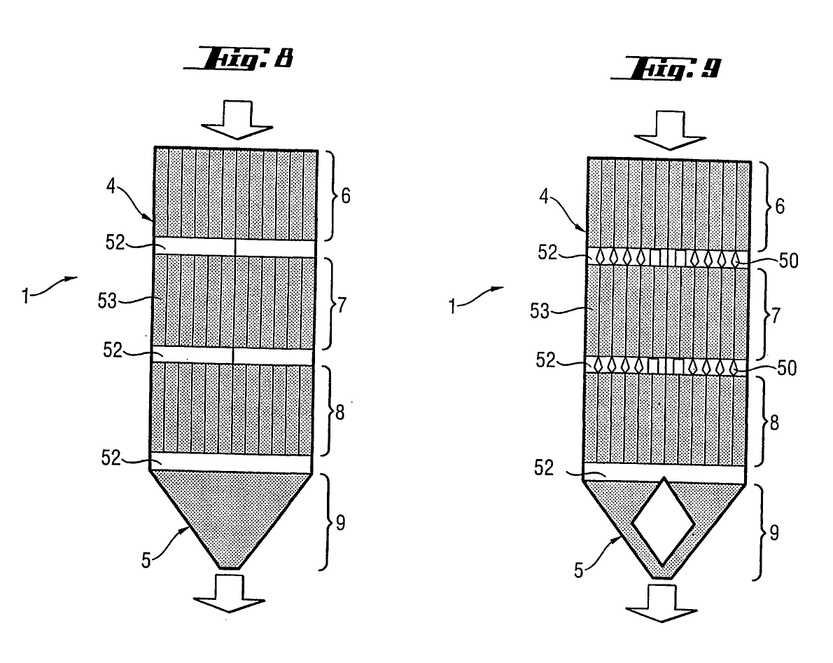

FIG. 8 shows a schematic side view of a first embodiment of a shaft reactor;

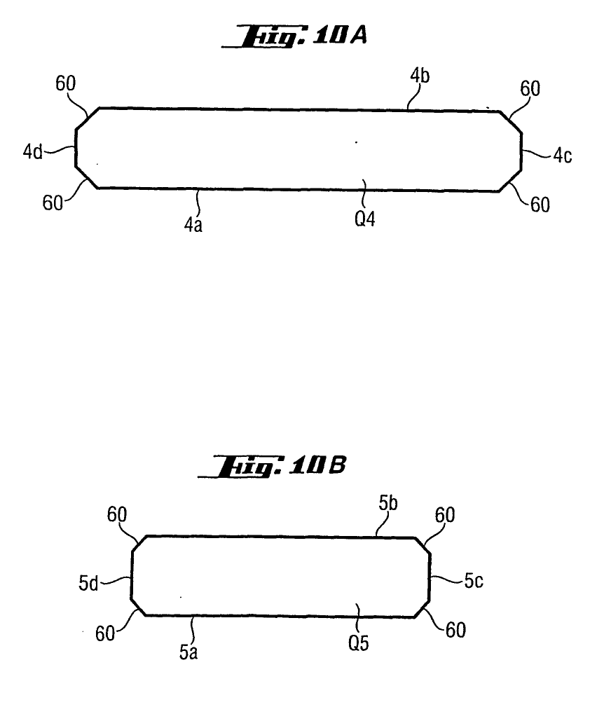

FIG. 9 shows a schematic side view of a second embodiment of a shaft reactor;

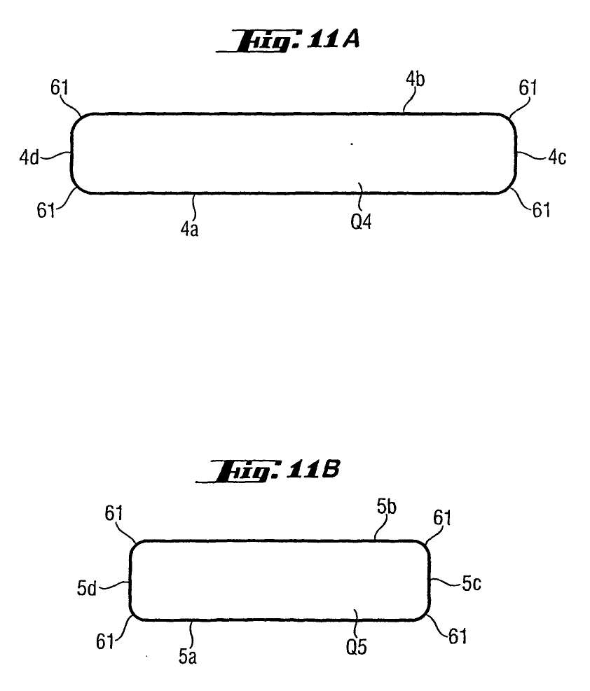

FIGS. 10A and 10B and

FIGS. 11A and 11B show detailed views of different horizontal sections Q4 and Q5 through the shaft reactor from FIG. 1.

FIG. 1 shows a schematic perspective view of shaft 1 according to this invention, consisting of an upper area 4 and a lower area 5. An inlet port 2 is provided at the upper end of the upper area 4, and an outlet port 3 is provided at the lower end of the lower area 5. The upper area 4 is bordered by 4 vertical shaft walls 4a, 4b, 4c and 4d and has a constant horizontal cross section Q4 over its entire height.

A lower area 5 which is bordered by four essentially vertical shaft walls Sa, 5b, 5c and 5d follows the upper area 4.

The horizontal cross section Q5 of the lower area 5 decreases continuously from top to bottom.

Sides 5a and 5b of the lower area are designed with a trapezoidal shape, while sides 5c and 5d of the lower area are designed with a rectangular shape. The lower area 5 is therefore tapered progressively from top to bottom in one dimension.

Gassing is performed through screen-like gassing areas (not shown) in the opposing large shaft walls 4a and 4b on the one hand and 5a and 5b on the other hand. The granules to be treated are added through the upper inlet port 2 and migrate under the influence of gravitation through the shaft 1, leaving at the lower outlet port 3.

To prevent caking of the partially sticky PET granules in the inside edge areas of shaft 1, edges 4e, 4f, 4g and 4h of the upper area 4 as well as edges 5e, 5f, 5g and 5h of the lower area 5 are tapered on the inside or are rounded (not shown), so that all the inside angles between adjacent shaft walls are larger than 90°.

Since the PET granules are usually cubicle or cylindrical in shape, this inclination or rounding of the walls prevents two surfaces of a granule from sticking to two perpendicular inside surfaces in the area of an inside edge.

FIGS. 2, 3, 4, 5 and 6 show various embodiments of trapezoidal slotted-hole screens for the lower area 5 of the shaft 1, where the slotted-hole screens form the opposing surfaces 5a and 5b of the outlet area 5.

FIG. 2 shows a trapezoidal slotted grid 10 in which the parallel slots of the slotted grid run parallel to the axis of symmetry A and perpendicular to the base sides 11 and 12 of the trapezoid. The inclined sides 13 and 14 of the trapezoid form an angle a with the axis of symmetry A, which amounts to between 10° and 30°, preferably approximately 20°.

Due to the essentially perpendicular orientation of the slots, the granules flowing through shaft 1 from top to bottom are hardly retarded at all, so this reduces the difference in velocity between the granules moving downward in the inner area of the shaft and the granules moving downward in the edge area of the shaft.

The gassing areas in the upper area 4 of the shaft are also formed by slotted-hole screens in which the slots run perpendicularly from top to bottom.

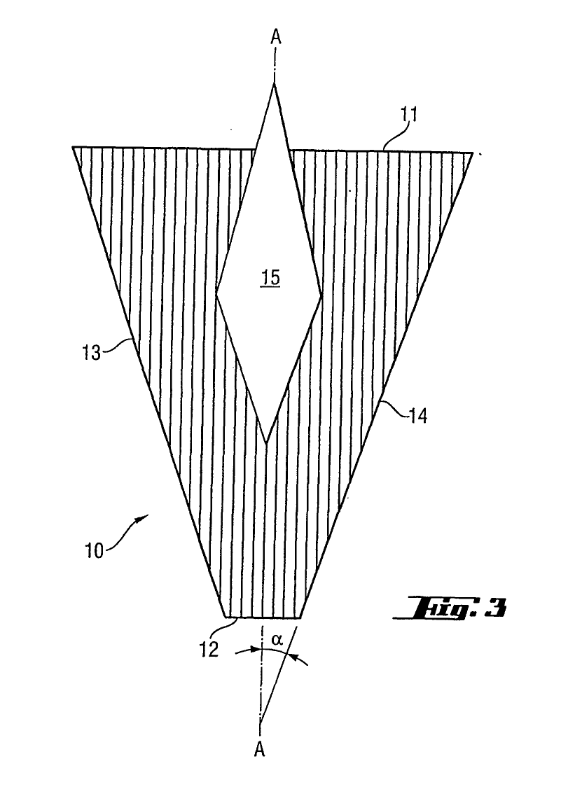

FIG. 3 shows the trapezoidal slotted-hole screen 10 from FIG. 2 in which an obstacle 15, a so-called diamond, is provided in the middle parallel to the axis A of symmetry. The diamond 15 extends continuously between the two slotted-hole screens 10, each forming the face 5a or 5b of the lower area 5 of shaft 1. The diamond has three functions.

Firstly, in the central area of shaft 1, it retards the granules migrating from top to bottom, thus making the vertical velocity of the granules flowing downward more uniform.

Secondly, due to its volume displacement, the diamond also reduces the portion of the outlet area where the granules would otherwise pass through with a significantly less uniform velocity distribution (without installation of the diamond).

Thirdly, the fixed connection of the diamond 15 with the opposite sides 5a and 5b of the outlet area 5 increases the stability of the entire installation. This is especially important because the force on the shaft walls is especially great in the lower area 5.

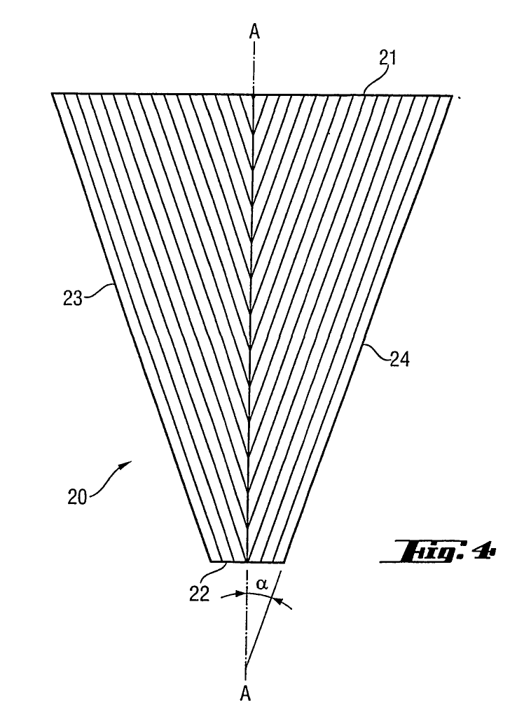

FIG. 4 shows another embodiment of a trapezoidal slotted-hole screen 20 for faces 5a and 5b of outlet area 5. The slotted-hole screen 20 consists of two halves which are arranged symmetrically with the axis of symmetry A. In each of the two halves of the trapezoid, the slots of the slotted-hole screen run parallel to one another and parallel to the respective inclined side 23 or 24. Thus the slots here do not run perpendicular to the base sides 21 and 22 of the trapezoid. This arrangement of the various slotted-hole screen areas achieves a very good uniformity of the vertical particle velocity over the entire horizontal cross section Q4 in the upper area 4 and horizontal cross section Q5 in the lower area 5 of the shaft.

This form of the trapezoidal slotted-hole screen may of course also be supplemented by a diamond 15, or the two embodiments may be used in combination.

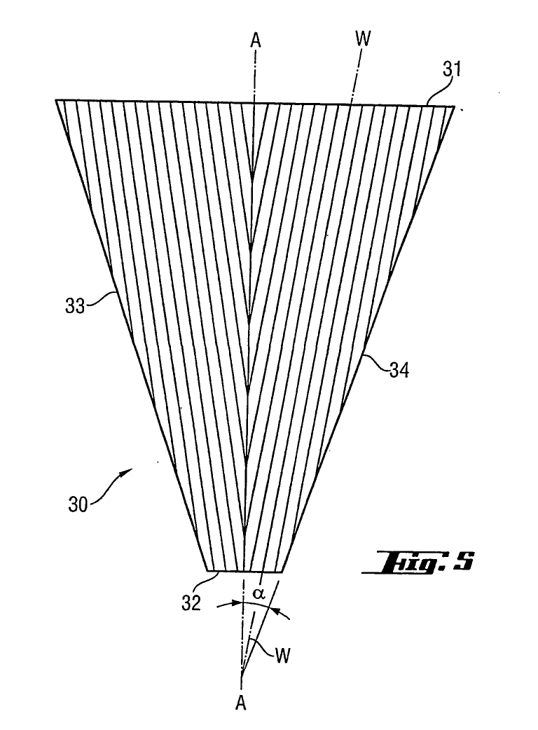

FIG. 5 shows another embodiment of a trapezoidal slotted-hole screen for faces 5a and b of outlet area 5.

As in FIG. 4, here again the trapezoidal slotted-hole screen consists of two areas that are symmetrical with the axis of symmetry A. Within each of the areas, the slots run parallel to one another and at the same time parallel to the angle dissecting line W between the axis of symmetry A and the inclined side 33 and 34 of the trapezoid. Here again, the slots do not run perpendicular to the base sides 31 and 32 of the trapezoid. This slotted-hole screen geometry achieves an especially uniform vertical velocity profile over the horizontal cross sections Q4 and Q5.

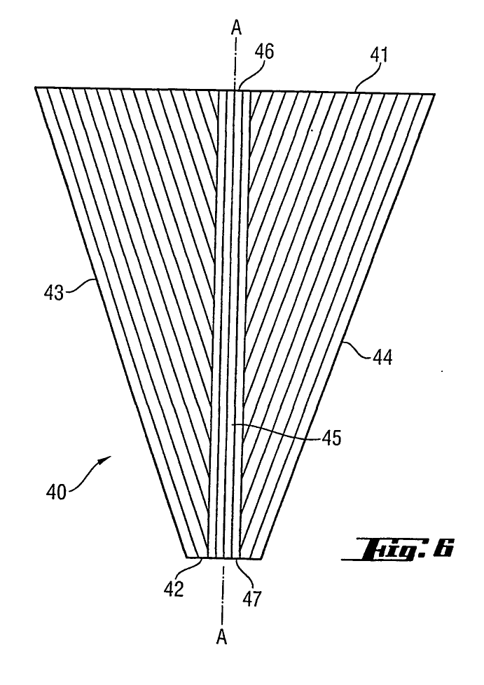

FIG. 6 shows another embodiment of a trapezoidal slotted-hole screen for faces 5a and 5b of the outlet area 5. The trapezoid here consists of base sides 41 and 42 as well as inclined sides 43 and 44.

Slotted-hole screen 40 is essentially identical to slotted-hole screen 4, but it also has in its central area a rectangular area that is symmetrical with the axis of symmetry A and whose slots run parallel to the axis of symmetry A. The upper and lower rectangular sides 46 and 47 form a part of the base side 41 and 42 of the trapezoidal slotted-hole screen. This slotted-hole screen 40 essentially achieves a largely perfect uniformity of the granule velocity profile over the entire horizontal cross section of shaft 1. The result is essentially identical to that obtained with slotted-hole screen 30 in FIG. 5.

However, this has an advantage in terms of production technology in comparison with the slotted-hole screen in FIG. 5 because there is less waste of material when cutting out the various slotted-hole screen areas. Another advantage is that the width of the central rectangular area, i.e., the length of rectangular sides 46 and 47, may be altered as needed.

Since the velocity profile of the granules over a horizontal cross section in the shaft depends on the shaft dimensions, the roughness of the inside wall surfaces as well as the properties and dimensions of the granules, an adapted correction for various shaft sizes as well as types of granules can be obtained by adjusting the width of the central rectangular area.

The various design features of FIGS. 2 through 6 may of course also be combined as needed.

FIG. 7 shows a schematic cross-sectional view along a sectional plane parallel to the opposing shaft sides 4a and 4b in FIG. 1. This shows on the whole ten roofs 50 which extend perpendicular to the plane of the drawing, i.e., perpendicular to sides 4a and 4b of upper area 4 of the shaft. The peaks 51 of the roofs point upward. The entire roof row is joined to sides 4a and 5a in a reinforced attachment area 52. Slotted-hole screen areas 53 extend toward both sides of the fastening area 52.

FIG. 8 shows a schematic side view of a first embodiment of a shaft reactor. Upper area 4 of shaft 1 has gassing areas 6, 7 and 8, while the lower area 5 of shaft 1 has a gassing area 9. There is one mounting area 52 between each of the gassing areas 6, 7, 8 and 9, which increases the stability of the entire shaft 1.

Each gassing areas 6, 7, 8 and 9 consists of a slotted-hole screen area 53.

FIG. 9 shows a schematic side view of another embodiment of the shaft reactor according to this invention. The embodiment in FIG. 9 differs from that in FIG. 8 through various obstacles in the interior of the shaft. Thus one roof row consisting of roofs 50 is arranged between the gassing areas 6 and 7 and another is arranged between gassing areas 7 and 8, and there is a diamond 15 in the outlet area 5.

Due to the canting of the granules relative to one another and due to an interaction between adhesive friction and sliding friction within the granules and between the granules and the inside walls of the shaft, stresses may build up in the granule flow and may be released suddenly from time to time. This leads to high loads on the entire shaft reactor. Due to the roof rows mounted at various heights in the upper area 4 of the shaft 1 and the changes in velocity of the granules thus achieved, the total volume of granules in shaft 1 is subdivided into different areas which correspond essentially to gassing areas 6, 7 and 8.

Due to this separation, the jerky release of stresses in the granules occurs only in the respective sub-areas 6, 7 and 8, so that the mass involved in such a jerky release of stress is much smaller than the total mass of granules. Mounting areas 52 in FIGS. 8 and 9 may be reinforced by flat bars of steel extending perpendicularly from the outside walls of shaft 1.

FIGS. 10A and 11A show detailed views of the horizontal cross section Q4. As they show, the horizontal cross section Q4 is only approximately rectangular.

All the inside edges of the upper area of shaft 1 are beveled or rounded, and this beveling 60 or rounding 61 causes all the inside angles in the edge area to be greater than 90°, which mostly prevents sticking of the granules, which are mainly cubicle or cylindrical in shape.

FIGS. 10B and 11B show detailed views of the horizontal cross section Q5 in the lower area 5 of shaft 1.

Here again, all the inside edges are beveled or rounded, and the beveling 60 or rounding 61 prevents caking of granules in the edge area. The bevels 60 may of course also be replaced by rounded corners 61, and these are less expensive to manufacture than the bevels mentioned above.

As this has shown, the slotted-hole screens yield gassable container walls without any great hindrance on the flow of material due to friction. When the granules come together in a small cross section of the transfer canal in outlet area 5, however, the direction of the slot has a great influence on the rate of flow of the granules and thus on the dwell time spectrum of granules in the outlet. The many long slots in the slotted-hole screen yield a high flow resistance if the granules cannot flow parallel to the slots, and it is also possible to deflect the direction of the granules through the direction of the slots.

The velocity profile and the dwell time spectrum can be influenced as desired through special arrangements of the slots, especially in the outlet area 5 of the shaft 1.

LIST OF REFERENCE NOTATION

| | |
|---|---|
| 1 | shaft |
| 2 | inlet port |
| 3 | outlet port |
| 4 | upper area |
| 5 | lower area |
| 6, 7, 8, 9 | gassing area |
| 4a, 4b, 4c, 4d | shaft walls, upper area |
| 5a, 5b, 5c, 5d | shaft walls, lower area |
| Q4 | horizontal cross section, upper area |
| Q5 | horizontal cross section, lower area |
| 4e, 4f, 4g, 4h | shaft edges, upper area |
| 5e, 5f, 5g, 5h | shaft edges, lower area |
| 10 | slotted-hole screen, trapezoidal |
| 20 | slotted-hole screen, trapezoidal |
| 30 | slotted-hole screen, trapezoidal |
| 40 | slotted-hole screen, trapezoidal |
| 11, 12 | base sides of slotted-hole screen 10 |
| 13, 14 | inclined sides of slotted-hole screen 10 |
| 15 | diamond-shaped obstacle |
| 21, 22 | base sides of slotted-hole screen 20 |
| 23, 24 | inclined sides of slotted-hole screen 20 |
| 31, 32 | base sides of slotted-hole screen 30 |
| 33, 34 | inclined sides of slotted-hole screen 30 |
| 41, 42 | base sides of slotted-hole screen 40 |
| 43, 44 | inclined sides of slotted-hole screen 40 |
| 45 | rectangular area of slotted-hole screen 40 |
| 46, 47 | rectangular sides of rectangle 45 |
| A | axis of symmetry |
| W | angle bisecting line |
| α | angle between axis of symmetry A and the |
| | inclined trapezoidal side |
| 50 | roof |
| 51 | upper peak of roof |
| 52 | mounting area |
| 53 | slotted-hole screen area |
| 60 | bevel |
| 61 | rounding |

1. A device for thermal treatment or aftertreatment of plastic material in granular form, in particular polyester material such as polyethylene terephthalate (PET), having a vertical shaft (1) which has an upper inlet port (2) and a lower outlet port (3) and in which the granules are guided vertically from top to bottom, whereby the shaft (1) has essentially an upper area (4) whose rectangular horizontal cross section Q4 is essentially constant along the vertical direction and has a lower area (5) whose horizontal cross section Q5 tapers downward in the vertical direction, and whereby the vertical shaft walls have screen-like areas at least in partial regions which permit transverse gassing of the granules with a gas mixture containing nitrogen, for example, whereby the screen-like partial areas for transverse gassing are arranged at least in the opposing shaft walls (4a, 4b, 5a, 5b), their horizontal width corresponding to the longer rectangular sides of the respective cross section Q4, Q5, characterized in that the inside faces of the shaft walls (4a, 4b, 4c, 4d, 5a, 5b, 5c, 5d) are made of a material having a smooth surface in at least partial areas (6, 7, 8, 9), the material having surface structures with certain preferential directions essentially corresponding to the dimensions of the grains of the granules.

2. The device according to claim 1, characterized in that the partial areas (6, 7, 8, 9) are gas-permeable gassing areas.

3. The device according to claim 1 or 2, characterized in that the shaft walls (4a, 4b, 5a, 5b) have screen-like regions or partial regions for transverse gassing of the granules in both the upper a (4) and in the lower area (5).

4. The device according to one of claims 1 through 3, characterized in that the screen-like areas or partial areas for the transverse gassing of granules consist of slotted-hole screens (10, 20, 30, 40) whose slot width is smaller than the smallest granule dimension.

5. The device according to claim 4, characterized in that the slots in the slotted-hole screens (10) run essentially in the vertical direction.

6. The device according to claim 4, characterized in that in the lower area (5) the horizontal cross section Q5 decreases from top to bottom in the vertical direction in at least one horizontal dimension, so that a funnel-shaped outlet is formed.

7. The device according to claim 6, characterized in that the funnel-shaped outlet (5) consists of a pair of opposing rectangular faces and a pair of opposing trapezoidal faces, whereby the rectangular faces are adjacent to the opposing shaft walls of the upper area (4) whose horizontal width corresponds to the shorter rectangular sides of cross section Q4.

8. The device according to claim 7, characterized in that the rectangular faces consist of slotted-hole screens whose slots run parallel to the rectangular sides.

9. The device according to claim 6, characterized in that the funnel-shaped outlet (5) consists of a first pair of opposing trapezoidal faces and a second pair of opposing trapezoidal faces.

10. The device according to claim 9, characterized in that with one of the pairs of trapezoidal faces (5a, 5b) which are connected to the broader shaft walls (4a, 4b), the trapezoidal faces consist of slotted-hole screens (10) whose slots run parallel to one another and perpendicular to the base sides (11, 12) of the respective trapezoidal face.

11. The device according to claim 9, characterized in that with one of the pairs of trapezoidal faces (5a, 5b) which are connected to the broader shaft walls (4a, 4b), the trapezoidal faces consist of slotted-hole screens (20) whose slots are arranged symmetrically with the axis of symmetry A of the trapezoidal face and run parallel to the inclined sides (23, 24) of the respective trapezoidal face on both sides of the axis of symmetry A.

12. The device according to claim 9, characterized in that with one of the pairs of trapezoidal faces (5a, 5b) connected to the broader shaft walls (4a, 4b), the trapezoidal faces consist of slotted-hole screens (30) in which the slots are arranged symmetrically with the axis of symmetry A of the trapezoidal face and run parallel to one another on both sides of the axis of symmetry A and run parallel to the angle dissecting line W between the axis of symmetry A and the respective inclined side (33, 34) of the trapezoidal face.

13. The device according to claim 11, characterized in that the trapezoidal face has a rectangular area (45) which extends symmetrically about the axis of symmetry A and whose sides run parallel or orthogonal to the base sides (41, 42) of the respective trapezoidal face, the slots running parallel to the axis of symmetry A of the trapezoidal face within the rectangular area (45).

14. The device according to one of claims 10 through 13, characterized in that the angle a between the axis of symmetry A of the trapezoidal face and the inclined sides (23, 24; 33, 34; 43, 44) of the trapezoidal faces is in the range between 10° and 30°, preferably approximately 20°.

15. The device according to claim 13, characterized in that the length of the rectangular sides (46, 47) which extend parallel to the base sides (41, 42) of the trapezoidal face is in a range which extends from approximately 1/10 the length of the larger base sides (41) of the trapezoidal face to the length of the smaller base side (42) of the trapezoidal face.

16. The device according to one of the preceding claims, characterized in that the ratio between the longer rectangular side L4 and the shorter rectangular side K4 of the cross section Q4 is between 20:1 and 5:1, preferably approximately 10:1, in the upper area (4).

17. The device according to one of the preceding claims, characterized in that all the inside edges (4e, 4f, 4g, 4h, 5e, 5f, Sg, 5h) are, beveled or rounded in the areas (4, 5) of the shaft (1), so that the horizontal cross sections Q4, Q5 are polygonal, oval (stadium bowl shape), in particular octagonal, and the horizontal cross sections Q4, Q5 are only approximately rectangular.

18. The device according to one of the preceding claims, characterized in that roofs (50) whose peaks (51) point upward are arranged in the interior of the shaft.

19. The device according to claim 18, characterized in that the roofs are arranged in several horizontal rows in the shaft (1), the rows being spaced a vertical distance apart.

20. The device according to one of claims 18 or 19, characterized in that the roofs (50) are mounted on the inside of the opposing large shaft walls (4a, 4b).

21. A method of thermal treatment or aftertreatment of plastic materials in granular form, in particular polyester materials such as polyethylene terephthalate (PET), using the device according to one of claims 1 through 19, whereby the method has the following steps:
feeding granules into the upper area of the shaft;
gassing the granules from both sides with air or gas as they move downward through the shaft, in particular gassing them with pure nitrogen at a temperature of 180° C. to 250° C. in the transverse direction through the screen-like partial areas of the upper region of the shaft;
gassing the granules on both sides with air, gas, in particular with pure nitrogen as the granules travel downward at a temperature of approximately 80° C. to 120° C. through the screen-like partial areas of the lower area of the shaft;
discharging the granules from the shaft through the funnel-shaped outlet.
